(19) United States
(12) Patent Application Publication
(10) Pub. No.: US 2025/0377679 A1
(43) Pub. Date: Dec. 11, 2025

(54) VOLTAGE REGULATOR LOAD CURRENT DETERMINATION UNDER A LIGHT-LOAD CONDITION

(71) Applicant: Qorvo US, Inc., Greensboro, NC (US)

(72) Inventor: Masashi Nogawa, Sachse, TX (US)

(21) Appl. No.: 19/199,489

(22) Filed: May 6, 2025

Related U.S. Application Data
(60) Provisional application No. 63/657,276, filed on Jun. 7, 2024.

(51) Int. Cl. G05F 1/565; G05F 1/575

(52) U.S. Cl. CPC G05F 1/565; G05F 1/575

(57) ABSTRACT

Voltage regulator load current determination under a light-load condition is disclosed. The voltage regulator is configured to generate an output current to charge an output capacitor to an output voltage. Specifically, the voltage regulator generates the output current in accordance with a duty cycle signal having multiple repeating duty cycle intervals. Under the light-load condition, during each of the duty cycle intervals, the output capacitor is charged by the output current for a portion of the duty cycle interval and discharged to maintain the output voltage above a threshold voltage for the remainder of the duty cycle interval. Herein, the voltage regulator is configured to estimate the load current based on a set of known parameters. As such, the voltage regulator can consistently report the load current throughout each of the duty cycle intervals independent of a presence and an absence of the output current.

### RELATED APPLICATIONS

This application claims the benefit of U.S. provisional patent application Ser. No. 63/657,276, filed on Jun. 7, 2024, the disclosure of which is hereby incorporated herein by reference in its entirety.

### FIELD OF THE DISCLOSURE

The technology of the disclosure relates generally to determining a load current in a switch-mode voltage regulator in an electronic power system.

### BACKGROUND

Electronic power systems are the enabling infrastructure technology that promotes conversion and distribution of electrical power from a power source to electronics and electrical machines. A power conversion circuit (a.k.a. voltage regulator) is often at the heart of each electronic power system to convert electrical power from raw form and quantity as produced by the power source to an appropriate form and quantity as needed by machines, motors, electronic equipment, and so on.

DC-DC conversion has always been an integral element of switch-mode power supplies that operate by toggling a main switch (e.g., transistor) between on- (a.k.a. closed) and off- (a.k.a. open) states. More specifically, the DC-DC conversion can be carried out by a buck (a.k.a. step-down) converter or a boost (a.k.a. step-up) converter. The buck converter passes energy directly to an output with a power inductor providing continuing current to the output when the main switch is in the off-state, whereas the boost converter stores all the output energy in the power inductor when the main switch is in the on-state and passes the stored energy to the output when the main switch is in the off-state.

### SUMMARY

Aspects disclosed in the detailed description are related to voltage regulator load current determination under a light-load condition. Herein, the voltage regulator is configured to generate an output current to charge an output capacitor to an output voltage. Specifically, the voltage regulator generates the output current in accordance with a duty cycle signal having multiple repeating duty cycle intervals. Under the light-load condition, during each of the duty cycle intervals, the output capacitor is charged for a portion of the duty cycle interval and discharged to maintain the output voltage above a threshold voltage for the remainder of the duty cycle interval. Accordingly, the voltage regulator will not be able to measure the load current that flows from the output capacitor into a load circuit. In embodiments disclosed herein, the voltage regulator is configured to estimate the load current based on a set of known parameters. As a result, the voltage regulator is able to consistently report the load current (e.g., to a master control unit) throughout each of the duty cycle intervals independent of a presence and an absence of the output current.

In one aspect, a voltage regulator is provided. The voltage regulator includes a voltage output. The voltage output provides an output voltage to a load circuit coupled to the voltage output to thereby cause a load current in the load circuit. The voltage regulator also includes an output capacitor. The output capacitor is coupled to the voltage output and periodically charged by an output current to thereby maintain the output voltage at the voltage output. The voltage regulator also includes a current generation circuit. The current generation circuit is configured to generate a duty cycle signal having multiple duty cycle intervals each divided into a current-on duration and a current-off duration. The current generation circuit is also configured to maintain the output current at the voltage output during the current-on duration in each of the multiple duty cycle intervals. The current generation circuit is also configured to remove the output current from the voltage output during the current-off duration in each of the multiple duty cycle intervals. The current generation circuit is also configured to estimate and report the load current in the load circuit throughout each of the multiple duty cycle intervals regardless of the presence and the absence of the output current.

In another aspect, an electronic power system is provided. The electronic power system includes a voltage regulator. The voltage regulator includes a voltage output. The voltage output provides an output voltage to a load circuit coupled to the voltage output to thereby cause a load current in the load circuit. The voltage regulator also includes an output capacitor. The output capacitor is coupled to the voltage output and periodically charged by an output current to thereby maintain the output voltage at the voltage output. The voltage regulator also includes a current generation circuit. The current generation circuit is configured to generate a duty cycle signal having multiple duty cycle intervals each divided into a current-on duration and a current-off duration. The current generation circuit is also configured to maintain the output current at the voltage output during the current-on duration in each of the multiple duty cycle intervals. The current generation circuit is also configured to remove the output current from the voltage output during the current-off duration in each of the multiple duty cycle intervals. The current generation circuit is also configured to estimate and report the load current in the load circuit throughout each of the multiple duty cycle intervals regardless of the presence and the absence of the output current.

In another aspect, a method for determining a voltage regulator load current under light-load condition is provided. The method includes providing an output voltage to a load circuit to thereby cause a load current in the load circuit. The method also includes periodically charging an output capacitor by an output current to thereby maintain the output voltage. The method also includes generating a duty cycle signal having multiple duty cycle intervals each divided into a current-on duration and a current-off duration. The method also includes maintaining the output current during the current-on duration in each of the multiple duty cycle intervals. The method also includes removing the output current during the current-off duration in each of the multiple duty cycle intervals. The method also includes estimating and reporting the load current in the load circuit throughout each of the multiple duty cycle intervals regardless of the presence and the absence of the output current.

Those skilled in the art will appreciate the scope of the disclosure and realize additional aspects thereof after reading the following detailed description in association with the accompanying drawings.

### BRIEF DESCRIPTION OF THE DRAWINGS

The accompanying drawings incorporated in and forming a part of this specification illustrate several aspects of the disclosure and, together with the description, serve to explain the principles of the disclosure.

FIG. 1A is a schematic diagram of an exemplary existing voltage regulator having difficulty in consistently reporting a load current under a light-load condition;

FIG. 1B is a diagram providing an exemplary illustration as to how the existing voltage regulator operates under a normal-load condition;

FIG. 1C is a diagram providing an exemplary illustration as to how the existing voltage regulator operates under the light-load condition;

FIG. 2 is a schematic diagram of an exemplary voltage regulator wherein a load current determination circuit is configured according to an embodiment of the present disclosure to consistently report a load current under the light-load condition;

FIG. 3 is a diagram providing an exemplary illustration as to how the voltage regulator of FIG. 2 operates under the light-load condition;

FIG. 4 is a schematic diagram providing an exemplary illustration of the load current determination circuit in FIG. 2;

FIG. 5 is a schematic diagram of an exemplary electronic power system wherein the voltage regulator of FIG. 2 can be provided; and

FIG. 6 is a flowchart of an exemplary process whereby the voltage regulator of FIG. 2 can be configured to report the load current under the light-load condition.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Aspects disclosed in the detailed description are related to voltage regulator load current determination under a light-load condition. Herein, the voltage regulator is configured to generate an output current to charge an output capacitor to an output voltage. Specifically, the voltage regulator generates the output current in accordance with a duty cycle signal having multiple repeating duty cycle intervals. Under the light-load condition, during each of the duty cycle intervals, the output capacitor is charged by the output current for a portion of the duty cycle interval and discharged to maintain the output voltage above a threshold voltage for the remainder of the duty cycle interval. Accordingly, the voltage regulator will not be able to measure the load current that flows from the output capacitor into a load circuit. In embodiments disclosed herein, the voltage regulator is configured to estimate the load current based on a set of known parameters. As a result, the voltage regulator is able to consistently report the load current (e.g., to a master control unit) throughout each of the duty cycle intervals independent of the presence and the absence of the output current.

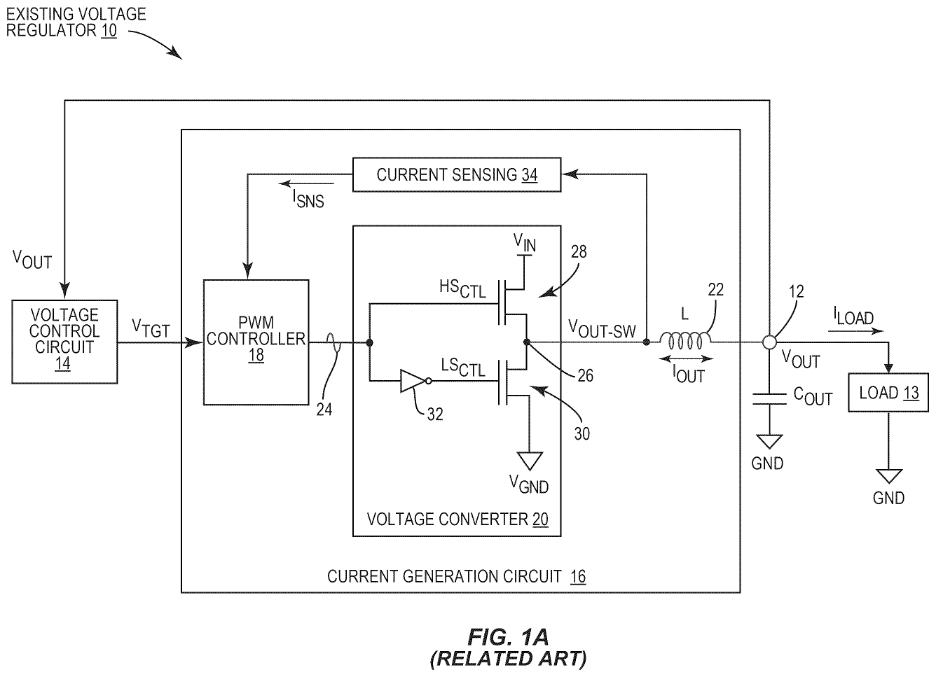

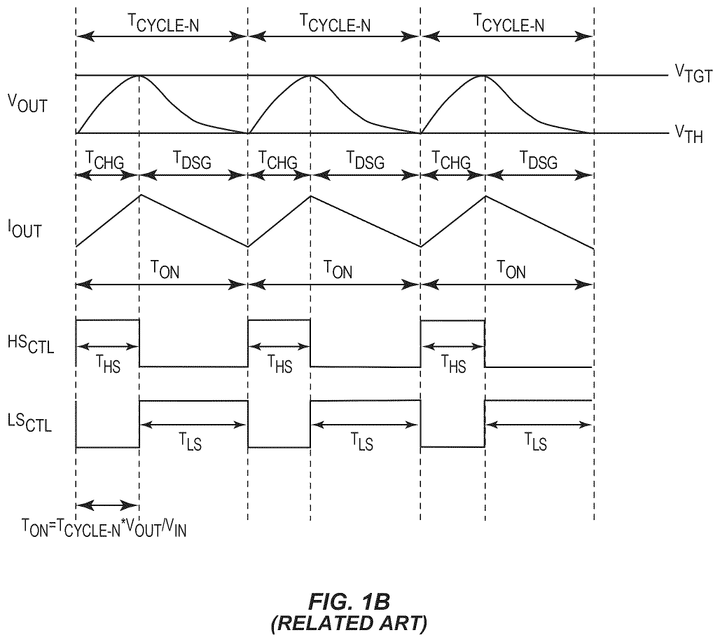

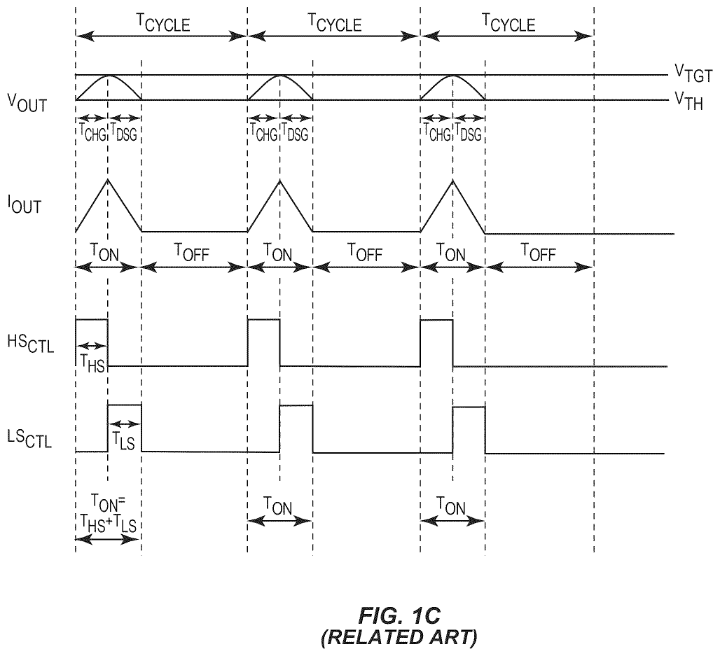

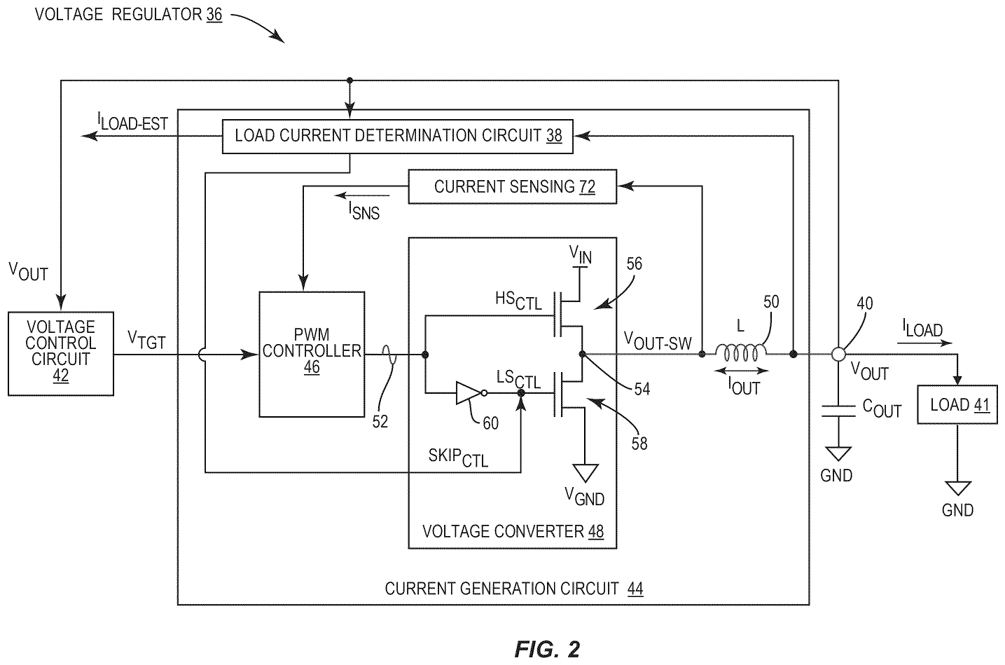

Before discussing the voltage regulator of the present disclosure, starting at FIG. 2, a brief overview of an existing voltage regulator is first provided with reference to FIGS. 1A-1C to help identify the technical problems to be solved herein.

FIG. 1A is a schematic diagram of an exemplary existing voltage regulator 10 having difficulty in consistently reporting an output current I_{OUT} under a light-load condition. The existing voltage regulator 10, which may be a switch-mode voltage regulator, includes an output capacitor C_{OUT} that is coupled to a voltage output 12. The output capacitor C_{OUT} can be charged by the output current I_{OUT} to thereby provide an output voltage V_{OUT} at the voltage output 12. Herein, the voltage output 12 is further coupled to a load circuit 13, which draws a load current I_{LOAD} from the existing voltage regulator 10.

The existing voltage regulator 10 includes a voltage control circuit 14 and a current generation circuit 16. The voltage control circuit 14 is configured to determine a target of the output voltage V_{OUT} (referred to as “target voltage V_{TGT}” hereinafter) that indicates an expected level of the output voltage V_{OUT}. The current generation circuit 16 is configured to generate the output current I_{OUT} to thereby charge the output capacitor C_{OUT} to the output voltage V_{OUT} indicated by the target voltage V_{TGT}.

The current generation circuit 16 includes a pulse-width modulation (PWM) controller 18, a voltage converter 20, and a power inductor 22. The PWM controller 18 is configured to generate a duty cycle signal 24 in accordance with the target voltage V_{TGT}. The voltage converter 20 is configured to generate a switching voltage V_{OUT-SW} at a switching node 26 based on an input voltage V_{IN} and in accordance with the duty cycle signal 24. The power inductor 22, which has an inductance L, is coupled between the switching node 26 and the voltage output 12. The power inductor 22 is configured to source the output current I_{OUT} when the switching voltage V_{OUT-SW} at the switching node 26 is higher than the output voltage V_{OUT} at the voltage output 12 or sink the output current I_{OUT} when the switching voltage V_{OUT-SW} at the switching node 26 is lower than the output voltage V_{OUT}.

Specifically, the voltage converter 20 includes a high-side transistor 28 and a low-side transistor 30. The high-side transistor 28 is coupled between the input voltage V_{IN} and the switching node 26, whereas the low-side transistor 30 is provided between the switching node 26 and a ground voltage V_{GND} (e.g., 0 V). The high-side transistor 28 is biased and directed by a high-side control voltage HS_{CTL}, whereas the low-side transistor 30 is biased by a low-side control voltage LS_{CTL}, which is inverted from the high-side control voltage HS_{CTL} by an inverter 32.

When the high-side control voltage HS_{CTL} is asserted (e.g., held HIGH), the high-side transistor 28 is turned on to couple the input voltage V_{IN} to the switching node 26. Accordingly, the switching voltage V_{OUT-SW} is substantially close to the input voltage V_{IN} (minus the drop voltage of the high-side transistor 28). In the meantime, the low-side control voltage LS_{CTL} is de-asserted (e.g., held LOW) to turn off the low-side transistor 30.

When the high-side control voltage HS_{CTL} is de-asserted (e.g., held LOW), the low-side control voltage LS_{CTL} will be asserted (e.g., held HIGH). Accordingly, the high-side transistor 28 is turned off. In the meantime, the low-side transistor 30 is turned on to couple the ground voltage V_{GND} to the switching node 26. Accordingly, the switching voltage V_{OUT-SW} is substantially close to the ground voltage V_{GND} (minus the drop voltage of the low-side transistor 30).

To help understand how the existing voltage regulator 10 operates under a normal-load condition, FIG. 1B is now discussed. Common elements between FIGS. 1A and 1B are shown therein with common element numbers and will not be re-described herein.

The duty cycle signal 24 includes multiple repeating duty cycle intervals T_{CYCLE-N} (a.k.a. “normal-load duty cycle”). Herein, T_{CYCLE-N} also refers interchangeably to a duration of each duty cycle interval T_{CYCLE-N} under the normal-load condition, which is an inverse of a frequency of the duty cycle signal 24. Under the normal-load condition, during each of the duty cycle intervals T_{CYCLE-N}, the output capacitor C_{OUT} is charged by the output current I_{OUT} toward the target voltage V_{TGT} during a portion (referred to as a “charging duration T_{CHG}”) of the duty cycle interval T_{CYCLE-N} and discharged to maintain the output voltage V_{OUT} at or above a threshold voltage V_{TH} for the remainder (referred to as a “discharging duration T_{DSG}”) of the duty cycle interval T_{CYCLE-N}.

During the charging duration T_{CHG} period in each of the duty cycle intervals T_{CYCLE-N}, the high-side control voltage HS_{CTL} is asserted for a first duration T_{HS} to turn on the high-side transistor 28 and turn off the low-side transistor 30. During the discharging duration T_{DSG}, the low-side control voltage LS_{CTL} is then asserted for a second duration T_{LS} to turn on the low-side transistor 30 and turn off the high-side transistor 28. As such, the current generation circuit 16 will continuously source or sink the output current I_{OUT} during each of the duty cycle intervals T_{CYCLE-N}. In this regard, the output current I_{OUT} will be present for a current-on duration T_{ON} that can be determined by equation (Eq. 1) below.

$${T}_{ON} = {T}_{CYCLE - N} \times {V}_{OUT} / {V}_{IN} \qquad ( Eq . 1 )$$

To help understand how the existing voltage regulator 10 operates under the light-load condition, FIG. 1C is now discussed. Common elements between FIGS. 1A-1C are shown therein with common element numbers and will not be re-described herein.

The duty cycle signal 24 includes multiple repeating duty cycle intervals T_{CYCLE}. Herein, T_{CYCLE} also refers interchangeably to a duration of each duty cycle interval T_{CYCLE}, which is an inverse of a frequency of the duty cycle signal 24. Under the light-load condition, during each of the duty cycle intervals T_{CYCLE}, the output capacitor C_{OUT} is charged by the output current I_{OUT} toward the target voltage V_{TGT} and discharged to maintain the output voltage V_{OUT} at or above a threshold voltage V_{TH} during a portion (referred to as a “current-on duration T_{ON}”) of the duty cycle interval T_{CYCLE}, but has no activity (charged or discharged) during the remainder (referred to as a “current-off duration T_{OFF}”) of the duty cycle interval T_{CYCLE}.

In this regard, the current generation circuit 16 generates the output current I_{OUT} during the current-on duration T_{ON} but not during the current-off duration T_{OFF} in each of the duty cycle intervals T_{CYCLE}. More specifically, during a current-on duration T_{ON} period in each of the duty cycle intervals T_{CYCLE}, the high-side control voltage HS_{CTL} is first asserted for a first duration T_{HS} to turn on the high-side transistor 28 and turn off the low-side transistor 30, and the low-side control voltage LS_{CTL} is then asserted for a second duration T_{LS} to turn on the low-side transistor 30 and turn off the high-side transistor 28. Understandably, a sum of the first duration T_{HS} and the second duration T_{LS} is equal to the current-on duration T_{ON} (T_{ON}=T_{HS}+TLS). As such, the current generation circuit 16 will not source or sink the output current I_{OUT} during the current-off duration T_{OFF} in each of the duty cycle interval T_{CYCLE}.

With reference back to FIG. 1A, to better control the existing voltage regulator 10, the current generation circuit 16 is required to consistently report the load current I_{LOAD} to, for example, a master control unit (MCU) (not shown). In this regard, the voltage converter 20 further includes a current sensing circuit 34 to report a sensed output current I_{SNS}. Specifically, the current sensing circuit 34 may detect the output current I_{OUT} at either side of the power inductor 22 and generate the sensed output current I_{SNS} as a function of the output current I_{OUT}. However, when the existing voltage regulator 10 is operating under the light-load condition, the output current I_{OUT} is not always present across the power inductor 22. Thus, the technical problem to be solved herein is to consistently report the load current I_{LOAD} throughout each of the duty cycle intervals T_{CYCLE} under the light-load condition, regardless of whether the output current I_{OUT} is present in the current generation circuit 16.

In this regard, FIG. 2 is a schematic diagram of an exemplary voltage regulator 36 wherein a load current determination circuit 38 is configured according to an embodiment of the present disclosure to consistently report a load current I_{LOAD} under the light-load condition described above in FIGS. 1A-1C. As described in detail below, the load current determination circuit 38 is configured to estimate the load current I_{LOAD} based on a variety of known information regardless of whether the output current I_{OUT} is actually present in the voltage regulator 36. As a result, the voltage regulator 36 can consistently report the load current I_{LOAD}, thus solving the technical problem facing the existing voltage regulator 10.

The voltage regulator 36, which may be a switch-mode voltage regulator, includes an output capacitor C_{OUT} that is coupled to a voltage output 40. The output capacitor C_{OUT} can be charged by the output current I_{OUT} to thereby provide an output voltage V_{OUT} at the voltage output 40. Herein, the voltage output 40 is further coupled to a load circuit 41, which draws the load current I_{LOAD} from the voltage regulator 36.

Like the existing voltage regulator 10, the voltage regulator 36 includes a voltage control circuit 42 and a current generation circuit 44. The voltage control circuit 42 is configured to determine a target voltage V_{TGT} that indicates an expected level of the output voltage V_{OUT}. The current generation circuit 44 is configured to generate the output current I_{OUT} to thereby charge the output capacitor C_{OUT} to the output voltage V_{OUT} indicated by the target voltage V_{TGT}.

Besides the load current determination circuit 38, the current generation circuit 44 also includes a PWM controller 46, a voltage converter 48, and a power inductor 50. The PWM controller 46 is configured to generate a duty cycle signal 52 in accordance with the target voltage V_{TGT}. The voltage converter 48 is configured to generate a switching voltage V_{OUT-SW} at a switching node 54 based on an input voltage V_{IN} and in accordance with the duty cycle signal 52. The power inductor 50, which has an inductance L, is coupled between the switching node 54 and the voltage output 40. The power inductor 50 is configured to source the output current I_{OUT} when the switching voltage V_{OUT-SW} at the switching node 54 is higher than the output voltage Vou at the voltage output 40 or sink the output current I_{OUT} when the switching voltage V_{OUT-SW} at the switching node 54 is lower than the output voltage V_{OUT}.

Specifically, the voltage converter 48 includes a high-side transistor 56 and a low-side transistor 58. The high-side transistor 56 is coupled between the input voltage V_{IN} and the switching node 54, whereas the low-side transistor 58 is provided between the switching node 54 and a ground voltage V_{GND} (e.g., 0 V). The high-side transistor 56 is biased and directed by a high-side control voltage HS_{CTL}, whereas the low-side transistor 58 is biased by a low-side control voltage LS_{CTL}, which is inverted from the high-side control voltage HS_{CTL} by an inverter 60.

When the high-side control voltage HS_{CTL} is asserted (e.g., held HIGH), the high-side transistor 56 is turned on to couple the input voltage V_{IN} to the switching node 54. Accordingly, the switching voltage V_{OUT-SW} is substantially close to the input voltage V_{IN} (minus the drop voltage of the high-side transistor 56). In the meantime, the low-side control voltage LS_{CTL} is de-asserted (e.g., held LOW) to turn off the low-side transistor 58.

When the high-side control voltage HS_{CTL} is de-asserted (e.g., held LOW), the low-side control voltage LS_{CTL} will be asserted (e.g., held HIGH). Accordingly, the high-side transistor 56 is turned off. In the meantime, the low-side transistor 58 is turned on to couple the ground voltage V_{GND} to the switching node 54. Accordingly, the switching voltage V_{OUT-SW} is substantially close to the ground voltage V_{GND} (minus the drop voltage of the low-side transistor 58).

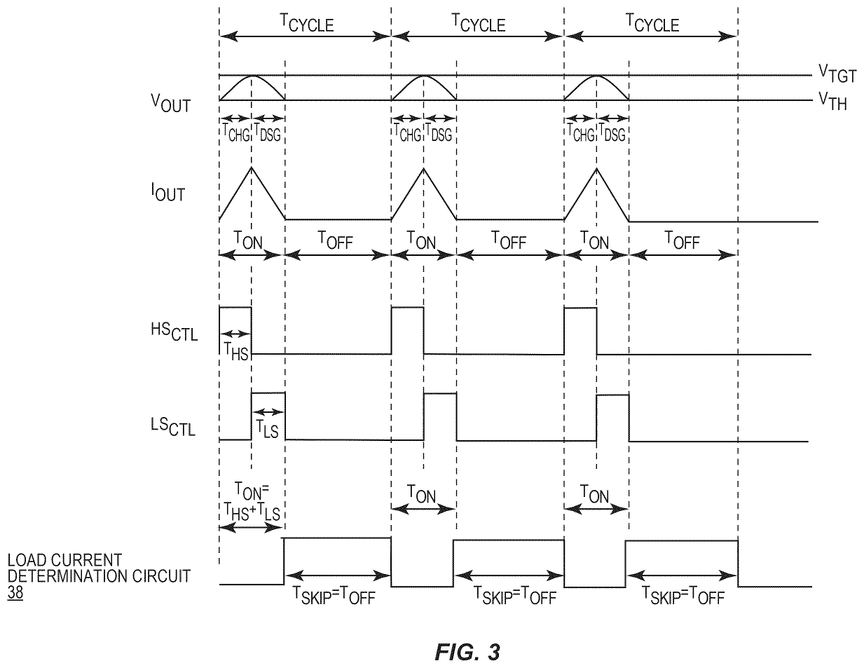

To help understand how the voltage regulator 36 operates under the light-load condition, FIG. 3 is now discussed. Common elements between FIGS. 2 and 3 are shown therein with common element numbers and will not be re-described herein.

Like in the existing voltage regulator 10, the duty cycle signal 52 also includes multiple repeating duty cycle intervals T_{CYCLE}. Herein, T_{CYCLE} also refers interchangeably to a duration of each duty cycle interval T_{CYCLE}, which is an inverse of a frequency of the duty cycle signal 52. Under the light-load condition, during each of the duty cycle intervals T_{CYCLE}, the output capacitor C_{OUT} is charged by the output current I_{OUT} toward the target voltage V_{TGT} and discharged to maintain the output voltage V_{OUT} at or above a threshold voltage V_{TH} during a portion (referred to as a “current-on duration T_{ON}”) of the duty cycle interval T_{CYCLE}, but has no activity (charged or discharged) for the remainder (referred to as a “current-off duration T_{OFF}”) of the duty cycle interval T_{CYCLE}.

In this regard, the current generation circuit 44 generates the output current I_{OUT} during the current-on duration T_{ON} but not in the current-off duration T_{OFF} during each of the duty cycle intervals T_{CYCLE}. More specifically, during the current-on duration T_{ON} in each of the duty cycle intervals T_{CYCLE}, the high-side control voltage HS_{CTL} is first asserted for a first duration T_{HS} to turn on the high-side transistor 56 and turn off the low-side transistor 58, and the low-side control voltage LS_{CTL} is then asserted for a second duration T_{LS} to turn on the low-side transistor 58 and turn off the high-side transistor 56. Understandably, a sum of the first duration T_{HS} and the second duration T_{LS} is equal to the current-on duration T_{ON} (T_{ON}=T_{HS}+T_{LS}).

The current generation circuit 44 differs from the current generation circuit 16 in the existing voltage regulator 10 in that the load current determination circuit 38 is configured to keep track of the current-off duration T_{OFF} in a timer value T_{SKIP} and use the timer value T_{SKIP} in conjunction with the input voltage V_{IN}, the output voltage V_{OUT}, the inductance L of the power inductor 50, and the duty cycle interval T_{CYCLE} to estimate the load current I_{LOAD}, independent of whether the output current I_{OUT} is actually present in the voltage regulator 36. As such, the voltage regulator 36 can consistently report the load current I_{LOAD} under the light-load condition.

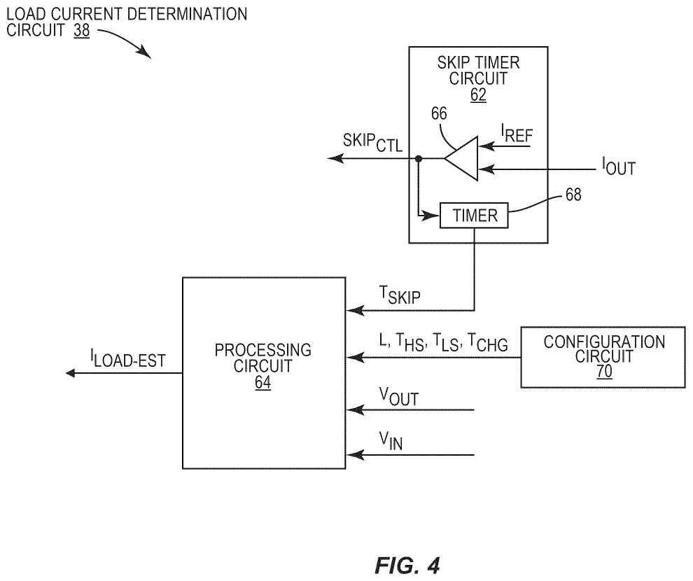

FIG. 4 is a schematic diagram providing an exemplary illustration of the load current determination circuit 38 in FIG. 2. Common elements between FIGS. 2 and 4 are shown therein with common element numbers and will not be re-described herein.

In an embodiment, the load current determination circuit 38 includes a skip timer circuit 62 and a processing circuit 64. The skip timer circuit 62 may include a comparator 66 and a timer 68. The comparator 66 is configured to compare the output current I_{OUT} flowing through the power inductor 50 against a reference current I_{REF} (e.g., 0 mA) to thereby detect a start of the current-off duration T_{OFF}. In response to detecting the start of the current-off duration T_{OFF}, the comparator 66 generates a skip control signal SKIP_{CTL}. The skip control signal SKIP_{CTL} serves two purposes. First, the skip control signal SKIP_{CTL} starts the timer 68 to thereby generate the timer value T_{SKIP}. Second, as illustrated in FIG. 2, the skip control signal SKIP_{CTL} can also cause the low-side transistor 58 to be turned off.

The load current determination circuit 38 can also include a configuration circuit 70, which can further include such storage devices as register and flash memory. In a non-limiting example, the configuration circuit 70 can be preconfigured to store the inductance L of the power inductor 50, the first duration T_{HS}, the second duration T_{LS}, and/or the current-on duration T_{ON}.

The processing circuit 64 can be configured to estimate the load current I_{LOAD} based on the timer value T_{SKIP}, the input voltage V_{IN}, the output voltage V_{OUT}, the inductance L of the power inductor 50, and the current-on duration T_{ON} to estimate the output current I_{OUT}. Specifically, the processing circuit 64 can estimate the load current ILOAD-EST according to equation (Eq. 2) below.

$${I}_{LOAD - EST} = [ ( {T}_{ON}^{2} / L ) \times 1 / 2 {V}_{OUT} \times ( 1 - {V}_{OUT} / {V}_{IN} ) ] / {T}_{CYCLE} \qquad ( Eq . 2 )$$

Herein, the current-on duration T_{ON} can be determined based on the equation (Eq. 1) above. Moreover, to estimate the load current I_{LOAD} based on the timer value T_{SKIP}, a sum of the first duration T_{HS} and the second duration T_{LS} is set to be equal to the current-on duration T_{ON} (T_{HS}+T_{LS}=T_{ON}).

With reference back to FIG. 2, the voltage converter 48 further includes a current sensing circuit 72. The current sensing circuit 72 may be configured to detect the output current I_{OUT} under or outside the light-load condition.

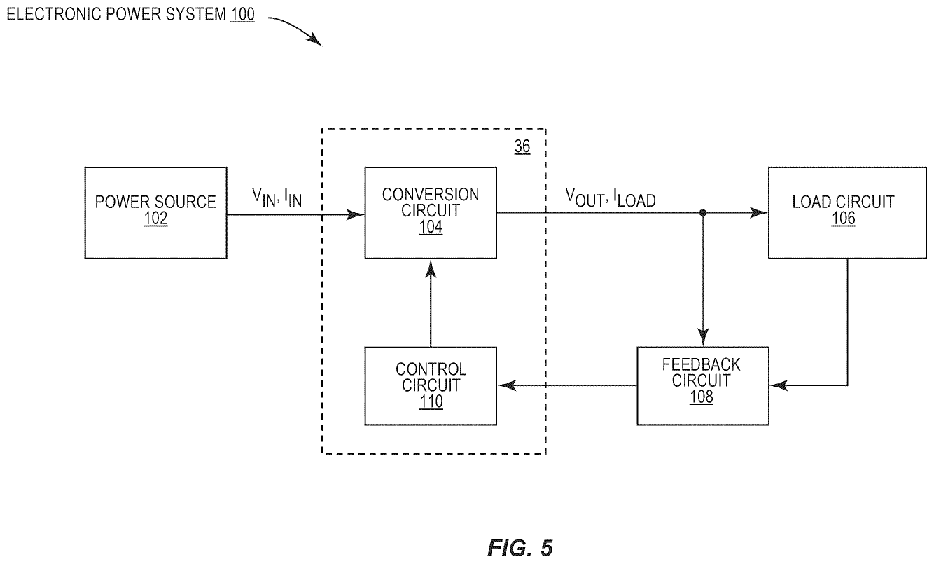

The voltage regulator 36 of FIG. 2 can be provided in an electronic power system to perform the functionalities described herein. In this regard, FIG. 5 is a schematic diagram of an exemplary electronic power system 100 wherein the voltage regulator 36 of FIG. 2 can be provided.

In an embodiment, the electronic power system 100 includes a power source 102, a conversion circuit 104, a load circuit 106, a feedback circuit 108, and a control circuit 110. The power source 102, which can be an AC or a DC power source, is configured to generate an input voltage V_{IN} and/or an input current I_{IN}.

The conversion circuit 104 is configured to convert the input voltage V_{IN} and/or the input current I_{IN} into an output voltage V_{OUT} and/or a load current I_{LOAD}. The conversion circuit 104 may be a step-down converter that converts a higher input voltage V_{IN} and/or a lower input current I_{IN} to a lower output voltage V_{OUT} and/or a higher load current I_{LOAD}. The conversion circuit 104 may be a step-up converter that converts a lower input voltage V_{IN} and/or a higher input current I_{IN} to a higher output voltage V_{OUT} and/or a lower load current I_{LOAD}. The conversion circuit 104 may also be a step-down and step-up converter that can toggle between step-down and step-up operations in accordance with a duty cycle to produce the output voltage V_{OUT} and/or the load current I_{LOAD} at any level.

The load circuit 106 can be any type of electrical circuit, such as an electric vehicle (EV) motor, EV battery, power grid, data center server, and so on. The conversion circuit 104 is configured to provide the output voltage V_{OUT} and/or the load current I_{LOAD} to the load circuit 106 via any suitable transmission medium.

The feedback circuit 108 is configured to provide various feedback to the control circuit 110. As an example, the feedback circuit 108 can dynamically measure the output voltage V_{OUT} and/or the load current I_{LOAD} being received by the load circuit 106 and report the measurement results to the control circuit 110, either in real time or with hysteresis. The feedback circuit 108 may also monitor operating conditions (e.g., load impedance, operating frequency, thermal temperature, etc.) in the load circuit 106 and report such conditions to the control circuit 110. The control circuit 110, in turn, can dynamically control the conversion circuit 104 to adjust the output voltage V_{OUT} and/or the load current I_{LOAD} based on the various feedback provided by the feedback circuit 108.

In an embodiment, the conversion circuit 104 and the control circuit 110 can be replaced by the voltage regulator 36 of FIG. 2. It should be appreciated that the voltage regulator 36 may also be provided in any other circuits in the electronic power system 100.

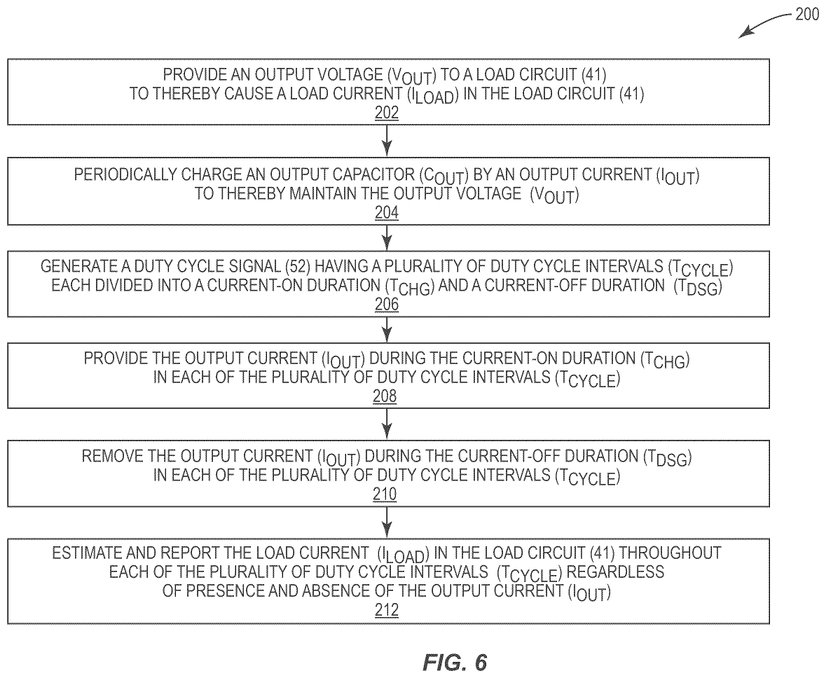

In an embodiment, the voltage regulator 36 of FIG. 2 can be configured to determine the load current I_{LOAD} under the light-load condition based on a process. In this regard, FIG. 6 is a flowchart of an exemplary process 200 whereby the voltage regulator 36 of FIG. 2 can be configured to determine the load current I_{LOAD} under the light-load condition.

Herein, the process 200 includes providing the output voltage V_{OUT} to the load circuit 41 to thereby cause the load current I_{LOAD} in the load circuit 41 (step 202). The process 200 also includes periodically charging the output capacitor C_{OUT} by the output current I_{OUT} to thereby maintain the output voltage V_{OUT} (step 204). The process 200 also includes generating the duty cycle signal 52 having multiple duty cycle intervals T_{CYCLE} each divided into the current-on duration T_{ON} and the current-off duration T_{OFF} (step 206). The process 200 also includes maintaining the output current I_{OUT} during the current-on duration T_{ON} in each of the duty cycle intervals T_{CYCLE} (step 208). The process 200 also includes removing the output current lout during the current-off duration T_{OFF} in each of the duty cycle intervals T_{CYCLE} (step 210). The process 200 also includes estimating and reporting the load current I_{LOAD} in the load circuit 41 throughout each of the duty cycle intervals T_{CYCLE} regardless of the presence and the absence of the output current I_{OUT} (step 212).

Those skilled in the art will recognize improvements and modifications to the embodiments of the present disclosure. All such improvements and modifications are considered within the scope of the concepts disclosed herein and the claims that follow.

What is claimed is:

1. A voltage regulator comprising:
a voltage output that provides an output voltage to a load circuit coupled to the voltage output to thereby cause a load current in the load circuit;
an output capacitor coupled to the voltage output and periodically charged by an output current to thereby maintain the output voltage at the voltage output; and
a current generation circuit configured to:
generate a duty cycle signal having a plurality of duty cycle intervals each divided into a current-on duration and a current-off duration;
maintain the output current at the voltage output during the current-on duration in each of the plurality of duty cycle intervals;
remove the output current from the voltage output during the current-off duration in each of the plurality of duty cycle intervals; and
estimate and report the load current in the load circuit throughout each of the plurality of duty cycle intervals regardless of a presence and an absence of the output current.

2. The voltage regulator of claim 1, wherein the current generation circuit is further configured to generate the duty cycle signal based on a target of the output voltage, and the voltage regulator further comprises a voltage control circuit configured to determine the target of the output voltage.

3. The voltage regulator of claim 2, wherein the current generation circuit comprises:
a pulse-width modulation (PWM) controller configured to generate the duty cycle signal based on the target of the output voltage and a feedback of the output voltage;
a voltage converter configured to generate a switching voltage at a switching node during the current-on duration in each of the plurality of duty cycle intervals based on an input voltage; and
a power inductor coupled between the switching node and the voltage output and configured to induce the output current during the current-on duration based on the switching voltage.

4. The voltage regulator of claim 3, wherein the PWM controller is further configured to determine the current-on duration and the current-off duration in each of the plurality of duty cycle intervals such that the output capacitor can be charged to the target of the output voltage during the current-on duration and discharged to maintain the output voltage at or above a threshold voltage during the current-off duration.

5. The voltage regulator of claim 3, wherein the current generation circuit further comprises a load current determination circuit that comprises:
a skip timer circuit configured to determine the current-off duration in each of the plurality of duty cycle intervals; and
a processing circuit configured to estimate the load current throughout each of the plurality of duty cycle intervals based on the input voltage, the output voltage, an inductance of the power inductor, the determined current-off duration in each of the plurality of duty cycle intervals, and a duration of each of the plurality of duty cycle intervals.

6. The voltage regulator of claim 5, wherein the processing circuit is further configured to estimate the output current as expressed as: I_{LOAD_EST}=[(T_{ON}²/L)×½V_{OUT}×(1−V_{OUT}/V_{IN})]/T_{CYCLE}, wherein:
I_{LOAD_EST} represents the load current estimated by the load current determination circuit;
T_{ON} represents the current-on duration of each of the plurality of duty cycle intervals, which is equal to T_{CYCLE-N}×V_{OUT}/V_{IN};
L represents the inductance of the power inductor;
V_{OUT} represents the output voltage;
V_{IN} represents the input voltage;
T_{CYCLE} represents the duration in each of the plurality of duty cycle intervals under a light-load condition; and
T_{CYCLE-N} represents the duration in each of the plurality of duty cycle intervals under a normal-load condition.

7. The voltage regulator of claim 5, wherein:
the voltage converter comprises a high-side transistor coupled between the input voltage and the switching node, and a low-side transistor coupled between the switching node and a ground voltage; and
the PWM controller is further configured to generate the duty cycle signal to:
turn on the high-side transistor and turn off the low-side transistor during a first duration of the current-on duration in each of the plurality of duty cycle intervals to thereby cause the switching voltage to be substantially equal to the input voltage; and
turn off the high-side transistor and turn on the low-side transistor during a second duration of the current-on duration in each of the plurality of duty cycle intervals to thereby cause the switching voltage to be substantially equal to the ground voltage.

8. The voltage regulator of claim 7, wherein the skip timer circuit is further configured to turn off the low-side transistor at a start of the current-off duration in each of the plurality of duty cycle intervals.

9. An electronic power system comprising a voltage regulator, the voltage regulator comprises:
a voltage output that provides an output voltage to a load circuit coupled to the voltage output to thereby cause a load current in the load circuit;
an output capacitor coupled to the voltage output and periodically charged by an output current to thereby maintain the output voltage at the voltage output; and
a current generation circuit configured to:
generate a duty cycle signal having a plurality of duty cycle intervals each divided into a current-on duration and a current-off duration;
maintain the output current at the voltage output during the current-on duration in each of the plurality of duty cycle intervals;
remove the output current from the voltage output during the current-off duration in each of the plurality of duty cycle intervals; and
estimate and report the load current in the load circuit throughout each of the plurality of duty cycle intervals regardless of a presence and an absence of the output current.

10. The electronic power system of claim 9, further comprising a power source and the load circuit, wherein the voltage regulator is coupled between the power source and the load circuit.

11. The electronic power system of claim 9, wherein the current generation circuit is further configured to generate the duty cycle signal based on a target of the output voltage and the voltage regulator further comprises a voltage control circuit configured to determine the target of the output voltage.

12. The electronic power system of claim 11, wherein the current generation circuit comprises:
a pulse-width modulation (PWM) controller configured to generate the duty cycle signal based on the target of the output voltage and feedback of the output voltage;
a voltage converter configured to generate a switching voltage at a switching node during the current-on duration in each of the plurality of duty cycle intervals based on an input voltage; and
a power inductor coupled between the switching node and the voltage output and configured to induce the output current during the current-on duration based on the switching voltage.

13. The electronic power system of claim 12, wherein the PWM controller is further configured to determine the current-on duration and the current-off duration in each of the plurality of duty cycle intervals such that the output capacitor can be charged to the target of the output voltage during the current-on duration and discharged to maintain the output voltage at or above a threshold voltage during the current-off duration.

14. The electronic power system of claim 12, wherein the current generation circuit further comprises a load current determination circuit that comprises:
a skip timer circuit configured to determine the current-off duration in each of the plurality of duty cycle intervals; and
a processing circuit configured to estimate the load current throughout each of the plurality of duty cycle intervals based on the input voltage, the output voltage, an inductance of the power inductor, the determined current-off duration in each of the plurality of duty cycle intervals, and a duration of each of the plurality of duty cycle intervals.

15. The electronic power system of claim 14, wherein the processing circuit is further configured to estimate the output current as expressed as: I_{LOAD_EST}=[(T_{ON}²/L)×½V_{OUT}×(1−V_{OUT}/V_{IN})]/T_{CYCLE}, wherein:
I_{LOAD_EST} represents the load current estimated by the load current determination circuit;
T_{ON} represents the current-on duration of each of the plurality of duty cycle intervals, which is equal to T_{CYCLE-N}×V_{OUT}/V_{IN};
L represents the inductance of the power inductor;
V_{OUT} represents the output voltage;
V_{IN} represents the input voltage;
T_{CYCLE} represents the duration in each of the plurality of duty cycle intervals under a light-load condition; and
T_{CYCLE-N} represents the duration in each of the plurality of duty cycle intervals under a normal-load condition.

16. The electronic power system of claim 14, wherein:
the voltage converter comprises a high-side transistor coupled between the input voltage and the switching node, and a low-side transistor coupled between the switching node and a ground voltage; and
the PWM controller is further configured to generate the duty cycle signal to:
turn on the high-side transistor and turn off the low-side transistor during a first duration of the current-on duration in each of the plurality of duty cycle intervals to thereby cause the switching voltage to be substantially equal to the input voltage; and
turn off the high-side transistor and turn on the low-side transistor during a second duration of the current-on duration in each of the plurality of duty cycle intervals to thereby cause the switching voltage to be substantially equal to the ground voltage.

17. The electronic power system of claim 16, wherein the skip timer circuit is further configured to turn off the low-side transistor at a start of the current-off duration in each of the plurality of duty cycle intervals.

18. A method for determining a voltage regulator load current under a light-load condition comprising:
providing an output voltage to a load circuit to thereby cause a load current in the load circuit;
periodically charging an output capacitor by an output current to thereby maintain the output voltage;
generating a duty cycle signal having a plurality of duty cycle intervals each divided into a current-on duration and a current-off duration;
maintaining the output current during the current-on duration in each of the plurality of duty cycle intervals;
removing the output current during the current-off duration in each of the plurality of duty cycle intervals; and
estimating and reporting the load current in the load circuit throughout each of the plurality of duty cycle intervals regardless of a presence and an absence of the output current.

19. The method of claim 18, further comprising determining the current-on duration and the current-off duration in each of the plurality of duty cycle intervals such that the output capacitor can be charged to a target of the output voltage during the current-on duration and discharged to maintain the output voltage at or above a threshold voltage during the current-off duration.

20. The method of claim 18, further comprising estimating the load current throughout each of the plurality of duty cycle intervals based on an input voltage, the output voltage, an inductance of a power inductor inducing the output current, the current-off duration in each of the plurality of duty cycle intervals, and a duration of each of the plurality of duty cycle intervals.
